(19) United States
(12) Patent Application Publication
(10) Pub. No.: US 2013/0290109 A1
(43) Pub. Date: Oct. 31, 2013

(54) Eliciting A Customer's Product Preference Propensities Among Sub-Groups In A Social Network

(71) Applicants: Zainab Jamal, Palo Alto, CA (US); Kay-Yut Chen, Santa Clara, CA (US); Filippo Balestrieri, Mountain View, CA (US)

(72) Inventors: Zainab Jamal, Palo Alto, CA (US); Kay-Yut Chen, Santa Clara, CA (US); Filippo Balestrieri, Mountain View, CA (US)

(21) Appl. No.: 13/457,668

(22) Filed: Apr. 27, 2012

(51) Int. Cl. G06Q 30/02

(52) U.S. Cl. 705/14.66

(57) ABSTRACT

A method to elicit a customer's product preference propensities among sub-groups, with each of the sub-groups having multiple members based on at least one common attribute, begins when customer action data is collected through the actions of the customer in the sub-group. The actions include the customer's propensities to purchase a product while within the sub-group and the customers' responses to displayed marketing messages or surveys while within the sub-group. The customer action data collected in the sub-group is analyzed to determine a customer's product preference propensities in the sub-group. The customer is targeted, when within the sub-group, with an electronic display that includes at least one product that corresponds to the customer's product preference propensities within the sub-group.

### BACKGROUND

Social media today gives a customer the ability to categorize his connections/friends into sub-groups based on common interest, where they are today, or where they have been throughout their lives. Sub-groups may be defined by the customer based on temporal attributes, spatial attributes and interest. More specifically, the sub-groups may be defined to include connections/friends in which the customer knew from a particular school, the customer has or currently works with, the customer lives near, or the customer shares a common interest or hobby with.

A customer's interactions and behaviors may vary amongst the different sub-groups. That is, how a customer interacts within a first sub-group may vary from how they interact within a second sub-group. In addition to a customer's interactions and behaviors in different sub-groups, a customer's product preference propensities may vary as well. Customers may be more willing to make a purchasing decision based on the sub-group they are in.

Advertising, including Internet and other interactive media advertising, is a fast-paced and high-stakes industry. In the advertising industry, the advantages of presenting attractive, attention-getting, and memorable advertisements are well recognized. Such advertisements may increase brand recognition, improve sales, and may be an integral part of a public relations campaign.

The advent of advertising networks involves electronic types of media enabling communications to and from consumers and/or the potential customers. These advertising networks provide a unique mechanism for presenting advertisements to targeted segments of the population through an almost infinite array of advertising publishers. Each targeted population segment is likely to have different preferences and thus a different response to any particular advertisement.

### DESCRIPTION OF THE DRAWINGS

FIG. 1 illustrates a block diagram of an embodiment of a customer's varying product preference propensities for a product among multiple sub-groups in a social network.

FIG. 2 illustrates an embodiment of a method for eliciting a customer's product preference propensities among sub-groups in a social network.

FIG. 3 illustrates an embodiment of a system and apparatus associated with eliciting a customer's product preference propensities among sub-groups in a social network.

### DETAILED DESCRIPTION

How customers interact or behave can vary between different groups of friends or connections in online social networks. Online social networking sites includes functionalities that make it possible for people to interact and share their preferences and choices with other people from different walks of their life, i.e., across time, geography and interests. With the use of customer created sub-groups, this may be done in a restricted manner, while opening up the possibilities for customers to have multiple preferences and purchase propensities for the same product or product category depending on which sub-group within their social network may view their preferences, choices and purchases. Further, these multiple preferences may be dependent as they are related to the same individual. While individuals have many product preference propensities that exist regardless of sub-groups, a particular product preference propensity may be enhanced when within a certain sub-group, thus making the customer more open to a purchasing decision. The basic concept is that customers have different preferences and behave differently based on their differing interactions within each of their sub-groups. For example, the preferences and choices made in the company of college friends may be different than those made in front of office colleagues or parents, especially where the product or the choice is visible.

According to an embodiment, a non-transitory computer readable medium having computer-executable instructions stored thereon for execution by a processor enables the processor to perform a method that elicits or estimates a customer's product preference propensities among sub-groups in a social network. A social network is an online service, platform, or site that focuses on building and reflecting social relationships among people, who, for example, share interests and/or activities and people with similar or somewhat similar interests, backgrounds and/or activities who make their own communities. In the example, the customer's social network maybe made up of multiple sub-groups in which a customer categorizes their friends/connections based on a common attribute. In the example, the customer can choose which of their friends/connections they want to include in a particular sub-group. A particular friend/connection of the customer may be placed in multiple sub-groups. For instance, a customer's golf friend, placed in a golf sub-group, may also be a college friend, placed in a college sub-group. The social network site allows the customer to keep the different sub-groups separate through different features and functionalities that allow their preferences to vary among the sub-groups.

The example method begins when a sub-group in a social network is created. The sub-group includes multiple members that are linked to the customer by a common attribute. Customer action data is collected through the actions of the customer within the sub-group. These actions include the customer's purchase of products, which defines purchase decision data while within the sub-group and the customers' responses to displayed marketing messages or the customer's sharing of choices while within the sub-group, which defines product response data. The customer action data collected in the sub-group is clustered, modeled and analyzed to determine a customer's product preference propensities in the sub-group. The customer action data may be clustered based on a data pattern identified in the product response data and product purchase data. The customer action data may be clustered based on responses to marketing messages, responses to referrals from friends, or purchase made while with a particular sub-group. For example, if the customer responds to a referral from a friend within a sub-group relating to a fishing product or service, the customer's action may be clustered into a fishing cluster. The clusters developed may be analyzed or modeled to estimate what common attributes exist among the members of a sub-group created by the customer. That is, while within a certain sub-group, what most interest the customer and may interest other members of the sub-group. Knowing this information may lead to specific advertisements or ads that are geared towards the customer while within a sub-group or other members of the sub-group. The example improves the overall effectiveness of marketing campaigns when customers are interconnected with other people through an online social network by analyzing customer behavior and their responses to marketing stimuli. The embodiment allows for the customer to be targeted, when within the sub-group, with an electronic display that includes at least one product corresponding to the customer's product preference propensities within the sub-group. For example, when a customer is in their golf related sub-group, an ad may be generated offering a golf related product or service to the customer.

The customer's product preference propensities, e.g., choices, responses, purchases, etc., within a sub-group may be different than the same customer's product preference propensities within another sub-group, even for the same product or product category. While a customer may have an interest in golf regardless of the sub-group they are in, the customer may be more responsive to golf advertisements while interacting within a sub-group created based on an interest in golf. Being within a sub-group includes the customers interactions with other friends/connections in the created sub-group. For example, these interactions can include, but are not limited to, instant messaging, video chatting, wall postings, or any other mechanism of interacting with friends/connections in the sub-group. A customer's interactions and behaviors may vary amongst the different sub-groups. That is, how a customer interacts with their golf buddies may vary from how they interact with their coworkers or parents. In addition to the variances between interactions and behaviors among the different sub-groups, a customer's product preference propensities may vary amongst the different sub-groups as well. The example method and system generates a customer's product preference ratings, e.g., their propensities for actions like choice, response or purchase, in an online social network when they have multiple and simultaneous preferences—one in each of their online social sub-groups where their behavior is observed by members of that sub-group. These sub-groups may be based on temporal attributes (people the customer met at different times in their life such as high school friends, college friends, colleagues, neighbors or family), spatial attributes (people the customer met where the customer grew up, went to college, worked, lived), interests (people met in communities linked to personal or work related interests like photography, cooking, econometrics) or some combination of these.

Determining a customer's product preference propensities in different sub-groups through the customer's actions in the sub-group may enable the social network site to offer more effective marketing services. The customer may be more enticed to view and/or respond to an ad related to golf when the customer is in their golf sub-group as opposed to being in their high school sub-group. In addition, the customer may be more responsive to a product recommendation or referral relating to golf, if that recommendation or referral is made by a member of their golf sub-group as opposed to a member of their coworkers sub-group. Knowing this may allow companies or social networks to more efficiently target the customer with products and advertisements that interest them and do so at times the customer might be most interested in such a product.

The example relates to a method and a system to determine a customer's product preference propensities amongst different sub-groups. The system includes a creating module, a data collection module, an analyzing module, and a customer target development module.

In a creating module, the customer creates a sub-group in which a customer categorizes their friends/connections based on a common attribute. The sub-group is created by a customer who may either join a particular sub-group or place certain friends/connections within their social network into a customer defined sub-group based on a common attribute among the friends/connections of the customer. For example, a customer may create a sub-group in which each of his golf buddies are designated members, so that communication with the sub-groups members may be controlled. In the example, the customer can choose which of their friends/connections they want to include in a particular sub-group and a particular friend/connection of the customer may be placed in multiple sub-groups.

In a data collection module, the social network site collects information relating to the customer's product preference propensities amongst the different sub-groups created by the customer. For example, while within a sub-group, a customer may respond to a banner ad that relates to a particular product by clicking a like or dislike option. If the customer clicks the like option, the social network may determine that the customer's product preference propensities within that sub-group are higher for the product referenced in the banner ad. Over time, data may be collected through multiple actions of the customer to elicit with a higher degree of certainty the customer's product preference propensities within that sub-group. The information collected defines a dataset having customer action data that includes product response data and product purchase data. The product response data may be collected and clustered through such actions as responding to a certain ad in a particular sub-group or liking/disliking a certain ad in a particular sub-group. The embodiment of the method may further include surveying a customer while within a created sub-group to ascertain a likelihood of the customer to purchase certain products and clustering the customer's sub-groups according to product clusters based on the likelihood of purchasing products. The product response data may further be collected through the customer's sharing of choices. That is, a customer may reveal their product preference propensities to the sub-group by their own volition. For example, a customer may comment in the sub-group form that the best color for a dress in summer is blue or comment that they hate black dresses in the middle of summer. As such, a customer's product preference propensity for a blue dress in summer is higher than it is for a black dress in summer. These clusters may be used to determine what interest a customer may have when within a particular sub-group so that ads may be targeted to that customer when within that sub-group. Marketing messages, banner ads, product referrals, a customer's sharing of choices, and surveys may be used to gather information about a customer's product preference propensities. The information may be used to cluster a customer's sub-group according to certain products. Further information regarding the customer and a customer's viewing/browsing behavior may be used to target product advertising to a particular sub-group of the customer where it might be the most effective. In addition, to product response data, product purchase data may be collected and clustered through such actions as observing the behavior of the customer to make purchases of a product while within a sub-group.

The analyzing module in the embodiment may include a model development portion and an analytics and diagnostics portion. In the model development portion, the output from the data collection module is analyzed and modeled to generate estimates for the customer's product preference propensities in each of the sub-groups. In addition, the attributes of the customer's social network may be computed. The model development portion determines which ads a customer would be most interested in now and in the future, within which sub-group the customer would be most vulnerable to such ads, which of a customer's connections/friends would be most influential in influencing the customer to respond to an advertisement, and the best route to target the customer.

The analytics and diagnostics portion uses the customer action data to generate reports for use by the social network in presenting their marketing services more effectively. Ultimately, the reports detail the best sub-group in which to target a particular customer and the best mode to target the customer. The reports may be generated at different levels of aggregation for the whole customer base, for the whole sub-group and for the individual customer.

Based on the reports generated, a customer target development module may generate or design an advertisement for a customer that corresponds to a particular product preference propensity within a sub-group as determined by the cluster, or includes a product that corresponds to the customer's interest within that sub-group. That is, the customer may be targeted when within the sub-group with an electronic display or advertisement that includes a product that corresponds to the customer's product preference propensities within that sub-group.

Online advertisement campaigns may include methods for publishing the advertisements, including search engine advertising, desktop advertising, online advertising directories, advertising networks, message (e.g., email, IM, SMS, MMS) advertising, and the like. Also, the advertisements themselves, may be published in different ways, including, but not limited to, text only ads, banner ads, popup ads, pop-under ads, interstitial ads, floating ads, expanding ads, wallpaper ads, video ads, audio ads, animated ads, trick banner ads, map ads, and/or the like. Placement of banner ads in this example embodiment includes determining in which sub-group to place a particular banner ad, and may include where on a particular website the banner ad appears.

A system of eliciting a customer's product preference propensities among sub-groups in a social network may include a data storage subsystem to store a dataset of customer action data that includes product purchase data that represents the customer's propensities to purchase a product while within the sub-group and product response data that represents the customer's responses to displayed marketing messages or surveys while within the sub-group, and the customer's sharing of choices within the sub-group. The system may further include a processing subsystem in communication with the data storage subsystem to perform the various steps of the methods of eliciting a customer's product preference propensities among sub-groups.

An apparatus, for example, a computer, which may include at least one computer and a computer network, elicits a customer's product preference propensities among sub-groups in a social network using a dataset of customer action data that includes product purchase data represented by the customer's propensities to purchase a product while within the sub-group and product response data represented by the customer's responses to displayed marketing messages or surveys while within the sub-group. The apparatus may include a creating module that creates a sub-group in the social network. The sub-group includes a plurality of members based on a common attribute amongst the members of the sub-group. The apparatus also may include a data collector that collects the customer action data through actions of the customer in the sub-group. The apparatus further may include an analyzer that uses the customer action data collected in the sub-group to determine the customer's product preference propensities in the sub-group. The apparatus may further include a targeting developer that develops an electronic display or advertisement to target the customer with a product based on the customer's product preference propensities within the sub-group.

These principles are discussed herein with respect to example processes, methods, system, and apparatus, and with reference to various diagrams. The example embodiments are shown and described as a series of blocks, but are not limited by this depiction, as the actions, steps, concepts, and principles associated with the illustrated blocks may occur in different orders than as described, and/or concurrently, and fewer or more than the illustrated number of blocks may be used to implement an example method. Blocks may be combined or include multiple components or steps.

The functional units described herein as steps, methods, processes, systems, subsystems, routines, modules, and so forth, may be implemented by at least one processor executing software. Executable code may include physical and/or logical blocks of computer instructions that may be organized as a procedure, function, and so forth. The executables associated with an identified process or method need not be physically collocated, but may include disparate instructions stored in different locations which, when joined together, collectively perform the method and/or achieve the purpose thereof. Executable code may be a single instruction or many, may be distributed across several different code segments, among different programs, across several memory devices, and so forth. Methods may be implemented on a computer, with the term “computer” referring herein to at least one computer and/or a computer network, or otherwise in hardware, a combination of hardware and software, and so forth.

FIG. 1 is an example block diagram that illustrates a customer's varying product preference propensities for a product among multiple sub-groups. As seen in FIG. 1, a customer i, having any number of social network sub-groups, k₁ to kₙ, may have different propensities P₁ to Pₙ for the product j₁. The customer's product preferences displayed within a sub-group may be different than the same customer's product preferences displayed in another sub-group, even for the same product or product category. A customer's i₁ product preference propensity P for a product j₁ in the sub-group k₁ may vary from that same customer's i₁ product preference propensity P₂, P₃, Pₙ for that same product j₁ in sub-groups k₂, k₃, kₙ and so on.

The example method and system generates a customer's product preference ratings i.e. their propensities for actions like choice, response or purchase in an online social network when they have multiple and simultaneous preferences—one in each of their online social network sub-groups where their behavior is observed by members of that sub-group. These sub-groups may be based on temporal attributes, spatial attributes, interests or some combination of these.

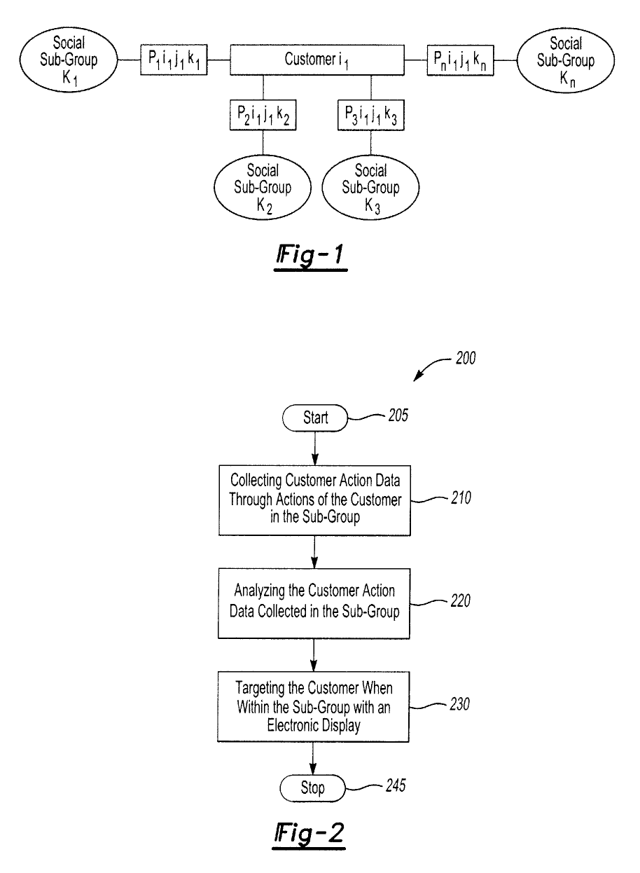

FIG. 2 illustrates an example method 200 to elicit a customer's product preference propensities among sub-groups, with each of the sub-groups having multiple members based on at least one common attribute. The method 200 begins when customer action data is collected through the actions of the customer in the sub-group. The actions include the customer's propensities to purchase a product while within the sub-group, the product purchase data, and the customers' responses to displayed marketing messages or surveys while within the sub-group, the product response data. The customer action data collected in the sub-group is modeled and analyzed to determine a customer's product preference propensities in the sub-group.

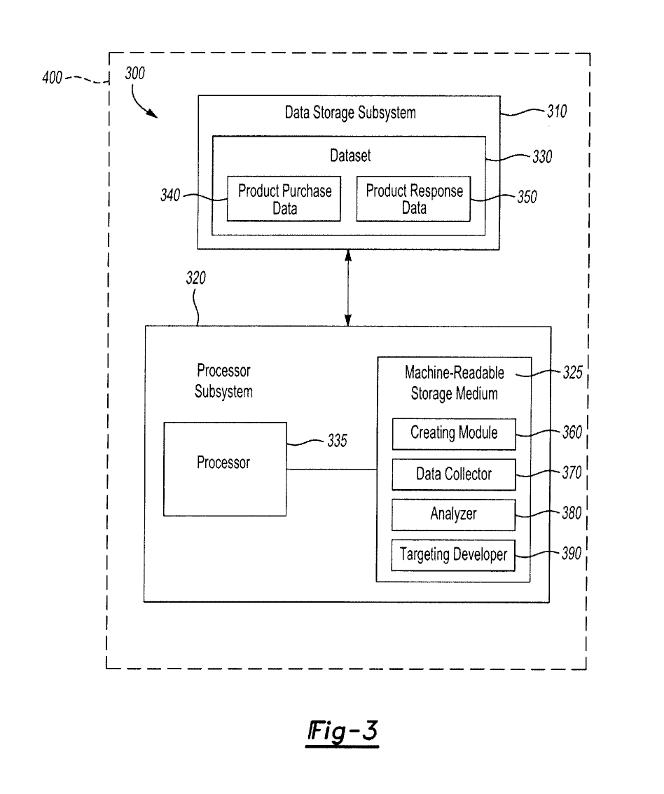

The example method 200 may be executed on a computer. For example, the method and/or process may be stored as logic encoded on a computer readable medium which, when executed by a processor, implements the method and/or process. The process may take place as part of an example system 300, as illustrated in FIG. 3, and/or within or by an apparatus 400, such as a computer.

The example method 200 shown in FIG. 2 is illustrated as a flow chart in which several of the above-described procedures are performed, for example by a computer or a computer network. Method 200 starts at block 205, and proceeds to block 210 where customer action data is collected through actions of the customer in the sub-group. According to the embodiment of the present disclosure, a social network may collect information about the preferences of its customers, particularly when within a sub-group created by the user. This includes information indicative of a customer's product preference propensity within a particular sub-group. Marketing messages, banner ads, product referrals, a customer's sharing of choices, and surveys may be used to gather information about a customer's product preference propensities. For example, while within a sub-group, a customer may respond to a banner ad relating to a particular product by clicking a like or dislike option. In addition, the customer may respond to a product referral from a member of the sub-group that relates to a particular product by liking or disliking the referral or purchasing the product or service referenced in the referral. Also, the customer may make a comment in the sub-group regarding a preference for a particular product. For example, a customer may comment in the sub-group form that the best color for a dress in summer is blue or comment that they hate black dresses in the middle of summer. As such, a customer's product preference propensity for a blue dress in summer is higher than it is for a black dress in summer. The information gathered may be used to cluster a customer's sub-group according to certain products. Further information regarding the customer and a customer's viewing/browsing behavior may be used to target product advertising to a particular sub-group of the customer where it might be the most effective. In addition, customer information may be collected through the purchases made by the customer while within the sub-group.

In the example, data may be collected in a data collection module. In this data collection module, the business customer or social network site collects information about the customer's product preference propensities in the different social sub-groups created by the customer. One route is through data sources like experiments and surveys from the customers in the social networking site about their propensity to purchase different products when in different sub-groups. The second route is through secondary data sources, i.e., observed purchase behavior for products, from the customer when they are in different sub-groups in the social network as well as from their responses to marketing messages from live experiments.

The example may include a dataset that includes product response data and product purchase data. Product response data may include responses to marketing messages, ads, product referrals, and surveys. In addition, product response data may further include the customer's sharing of choices. Some methods may be performed using existing survey data, whereas some methods may include compiling surveys directed to purchasing behavior. Purchasing behavior surveys may be compiled and administered for various reasons, such as to test the market for a particular product or product type. Product purchase data may include such actions as the customer making purchases of a product while within a sub-group.

The dataset may be clustered based on a data pattern identified in the product response data and product purchase data. That is the actions of the customer in the sub-group may be clustered into any number of clusters according to a data pattern identified in a dataset of the customer action data. The data pattern may relate to responses to selected questions while in a sub-group or a purchase made by the customer while in the sub-group. Some embodiments may include identifying the data pattern, such as by a market analyst, in which the question (or questions) used for clustering are selected from among those that are not associated with variables that are endogenously linked to purchasing decisions.

A clustering analysis is performed on the collected data in order to identify the products, or categories of products, by which sub-groups of the customer may be separated in terms of their product preference propensities within that sub-group. The reader will appreciate that through the collected information, product clustering analysis may determine that the customer within a first sub-group may have a preference for purchasing products of a first product classification, and that the same customer within a second sub-group may have a preference for purchasing products of a different classification. That is, through product clustering analysis, products and/or categories of products may be identified (e.g., clusters identification) that allow separating the customer's sub-groups based on the customer's product preference propensities within each of the sub-groups.

After customer action data is collected through actions of the customer in the sub-group, method 200 may then proceed to block 220, where the data collected in the sub-group is analyzed to determine a customer's product preference propensities in the sub-group. In the example, an analyzing module or analyzer having a model development portion and an analytics and diagnostics portion may be used to analyze the customer action data and determine a customer's product preference propensities in the sub-group.

The analyzing of the customer action data begins in the model development portion of an analyzer module. In the example analyzer module, the data collected is analyzed and preferences are estimated for the panel as well for the customer base based on appropriate weighing and generalization. From the customer action data associated with a given cluster, a model may be produced, by a computer, that defines the customer's product preference propensities within the sub-group. The first potential outcome of this model development portion is to provide the business customer or social network with a set of product purchase propensities for a given customer in their different social sub-groups in the current time period and predictions for the future time periods. The model generates the estimated preference structure of one customer across their different social sub-groups as well as the preference structure of a social sub-group across all the customers who belong to that sub-group for different products and categories of products. This gives the social network the ability to know what interest a customer currently has within a sub-group and would likely have in the future. Based on the customer action data collected, the social network may determine what the common attribute is that links the members of a sub-group. That is, the social network may determine what common interest or hobby links the members of a sub-group.

The second potential output from the model development portion is to recommend the best sub-group through which to promote a given product. That is, recommend the sub-group in which the customer has the highest propensity for this product. A recommendation may be made as to which of the customer's sub-groups is the best sub-group through which to target the customer directly. Based on the data collected, it may be determined what attribute links the members of a particular sub-group. Knowing this link, the social network may make product recommendations to the customer, taking into account the attribute in which the customer is most likely interested in within the sub-group.

The third set of output from the model development portion may recommend the set of customers who are the most influential to the target customer and likely to have the highest influence on the customer in this sub-group. By knowing the attribute that a sub-group is based on, and the members of the sub-group, the social network may make recommendations as to which members of a social network would be best suited to target the customer regarding a particular product. For example, if it is determined that a sub-group created by the customer relates to the college the customer attended or is a fan of, and that customer's friend F₁ is a member of that sub-group, the social network may gear ads related to the college and use friend F₁ as recommending or referring the product within the college advertisement.

The fourth set of output from the model development portion may recommend the best route to target customer. This may be determined by the method of advertisement the customer is most response to. For example, does the customer respond more frequently to marketing messages, banner ads, or member referrals. Based on this, the social network can determine which method of advertisement may be best suited to solicit a customer regarding a particular product.

In the example, the analyzing of the customer action data may continue in the analytics and diagnostics portion of the analyzer module. In the analytics and diagnostics portion, the customer action data is used to generate analytics reports with predictions and diagnostics at different levels of aggregation for the whole customer base, for sub-groups of a customer and for the individual customer. These reports will help marketing managers of the social networking site better package their marketing services and make their offerings more effective. These marketing services include, but are not limited to, preference weight prediction or what product a customer may be interested in within a particular sub-group or in general, the best sub-group through which to target the customer for a product, and the best route for targeting the customer.

After customer action data is analyzed to determine a customer's product preference propensities in the sub-group, method 200 may then proceed to block 230, where the customer is targeted, when within the sub-group, with an electronic display that includes a product that corresponds to the customer's product preference propensities within the sub-group. This may be accomplished by the customer target development module. Based on the reports generated, an advertisement may be generated or designed for a customer, that corresponds to a particular product preference propensity within a sub-group as determined by the cluster, to include a product that corresponds to the customer's interest within that sub-group. That is, the customer may be targeted when within the sub-group with an electronic display or advertisement that includes a product that corresponds to the customer's product preference propensities within that sub-group. For example, if the customer has an interest in golf and has a sub-group dedicated to golf, the customer can be targeted for golf related products specifically when he is in his golf sub-group. This targeting could include advertisements for golf products or recommendations from members of the customer's golf group for golf products. Method 200 may then proceed to block 245, where method 200 may stop.

The example may further include the optional step of creating a sub-group in a social network. This may be accomplished in a creating module. A social network is an online service, platform, or site that focuses on building and reflecting social relationships among people, who, for example, share interests and/or activities and people with similar or somewhat similar interests, backgrounds and/or activities who make their own communities. The sub-group includes multiple members that are based on a common attribute. The sub-group is created by a customer who may either join a particular sub-group or place certain friends/connections within their social network into a customer defined sub-group based on a common attribute among the friends/connections of the customer. For example, a customer may create a sub-group in which each of his golf buddies are designated members, so that communication with the sub-groups members may be controlled. In the example, the customer's social network is made up of multiple sub-groups and the social network site allows the customer to keep the different sub-groups separate through different features and functionalities that allow the customer's preferences to vary among the chosen sub-groups.

The example system 300 in FIG. 3 is shown as a block diagram that includes a data storage subsystem 310 in communication with a processing subsystem 320. Data storage subsystem 310 may be used to store a dataset 330 of customer action data. As noted above, the dataset may include product purchase data and product response data, indicated in FIGS. 3 at 340 and 350, respectively. The processing subsystem 320 includes a machine-readable storage medium 325 and a processor 335. The machine-readable storage system 325 is encoded with instructions to elicit a customer's product preference propensities among sub-groups in a social network. The processor 335 may be a central processing unit (CPU), a semiconductor-based microprocessor, or any other hardware device suitable for retrieval and execution of instructions stored in the machine-readable storage medium 325.

The dataset 330 stored and managed in the data processing subsystem 310 may be available to the processing subsystem 320, which may perform the various actions of the example method 200 disclosed above. For example, the processing subsystem 320 may generate a customer's product preference propensities among sub-groups in a social network using a dataset of customer action data that includes product purchase data representing the customer's propensities to purchase a product while within the sub-group and product response data representing the customer's responses to displayed marketing messages or surveys while within the sub-group. In some embodiments, the system 300 may incorporate at least one component and/or subcomponent to perform such actions. For example, processing subsystem 320, having the machine-readable storage medium 325, is shown to include a creating module 360 that creates a sub-group in the social network. The sub-group includes a plurality of members that are based on a common attribute. The processing subsystem 320 is shown to further include a data collector 370 that collects the customer action data through the actions of the customer in the sub-group. The processing subsystem 320 is shown to further include an analyzer 380 that uses the customer action data collected in the sub-group to determine the customer's product preference propensities in the sub-group. The processing subsystem 320 is shown to further include a targeting developer 390 that develops an electronic display or advertisement to target the customer with a product based on the customer's product preference propensities within the sub-group.

In some embodiments, these components may be thought of as collectively forming an apparatus 400 to elicit a customer's product preference propensities among sub-groups in a social network. Apparatus 400 may be a computer, or a computer network, and may physically house the components and subsystems of system 300, as shown in FIG. 3. For example, a computer may include at least one computer readable storage medium, such as a memory, and a processor operatively connected to the memory. The storage medium may carry data and instructions for operating on the data, or may take any suitable configuration.

With customers getting socially connected and with technology allowing them to manage these social sub-groups, the example method and system provides an advantage by allowing the managers of the social network sites and their customers to effectively reach out to these customers in the new paradigm. The example method and system further provides an advantage by eliciting a customer's product preference propensities in the current and future periods for the whole customer base, as well sub-groups and individual customers, to provide powerful insights for marketing strategy.

We claim:

1. A method for eliciting a customer's product preference propensities among sub-groups having a plurality of members based on at least one common attribute to target the customer with at least one product corresponding to the customer's product preference propensities within the sub-group, the method comprising:
collecting customer action data through actions of the customer in the sub-group, the customer action data including at least one of product purchase data and product response data;
analyzing the customer action data collected in the sub-group to determine the customer's product preference propensities in the sub-group; and
targeting the customer when within the sub-group with an electronic display having the at least one product corresponding to the customer's product preference propensities within the sub-group.

2. The method as set forth in claim 1 wherein collecting customer action data comprises clustering the actions of the customer in the sub-group into at least one cluster according to a data pattern identified in a dataset of the customer action data.

3. The method as set forth in claim 2 wherein analyzing the customer action data comprises producing, by a computer, from the customer action data associated with a given cluster of the at least one cluster, a model defining the customer's product preference propensities within the sub-group.

4. The method as set forth in claim 1 wherein analyzing the customer action data further comprises estimating member product preference propensities of other members of the sub-group based on the customer's product preference propensities within the sub-group.

5. The method as set forth in claim 1 further comprising eliciting a set of the customer's product preference propensities for the sub-group for a current time period.

6. The method as set forth in claim 1 further comprising eliciting a set of predictions of the customer's product preference propensities for the sub-group for future time periods.

7. The method as set forth in claim 1 further comprising recommending the sub-group of the customer for which to promote the at least one product based on the customer's product preference propensities within the subgroup.

8. The method as set forth in claim 1 further comprising recommending the route to target the customer within the sub-group based on the customer action data.

9. The method as set forth in claim 1 wherein targeting the customer when within the sub-group further comprises designing an advertisement for the customer when within the sub-group having the at least one product corresponding to the customer's product preference propensities within the sub-group.

10. The method as set forth in claim 1 wherein the customer action data includes data from both the product purchase data and the product response data.

11. The method as set forth in claim 1 wherein the product response data includes the customer's responses to at least one of displayed marketing messages, referrals, or surveys while within the sub-group, and the product purchase data includes the customer's purchase of products while within the sub-group.

12. The method as set forth in claim 1 further comprising creating at least one subgroup in a social network having the plurality of member based on the at least one common attribute amongst the member.

13. A system of eliciting a customer's product preference propensities among sub-group having a plurality of members based on at least one common attribute to target the customer with at least one product corresponding to the customer's product preference propensities within the sub-group, comprising:
a data storage subsystem for storing a dataset of customer action data including product purchase data representing the customer's propensities to purchase a product while within the sub-group and product response data representing the customer's responses to displayed marketing messages or surveys while within the sub-group;
a processing subsystem in communication with the data storage subsystem to:
collect customer action data through actions of the customer in the sub-group, the customer action data including at least one of the product purchase data and the product response data;
analyze the customer action data collected in the sub-group to determine the customer's product preference propensities in the sub-group; and
target the customer when within the sub-group with an electronic display having the at least one product that corresponds to the customer's product preference propensities within the sub-group.

14. The system as set forth in claim 13 wherein the data storage system further includes instructions to cluster the actions of the customer in the sub-group into at least one cluster according to a data pattern identified in a dataset of the customer action data.

15. The system as set forth in claim 13 wherein the data storage system further includes instructions to estimate member product preference propensities of other members of the sub-group based on the customer's product preference propensities within the sub-group.
